(19) United States
(12) Patent Application Publication
(10) Pub. No.: US 2005/0162425 A1
(43) Pub. Date: Jul. 28, 2005

(54) Dynamic mapping tool

(76) Inventors: Henry Martin Kyle, Coquitlam (CA); Stephen S. Penrod, Kansas City, MO (US)

Correspondence Address: FISH & RICHARDSON P.C., PO BOX 1022, MINNEAPOLIS, MN, 55440-1022, US

(21) Appl. No.: 10/763,476

(22) Filed: Jan. 23, 2004

(51) Int. Cl. G06T 11/20

(52) U.S. Cl. 345/442

(57) ABSTRACT

Systems and methods are provided for dynamically displaying a projection sensitive path on a two-dimensional representation of a three-dimensional object. In one aspect, a path is dynamically displayed between at least two geographic locations. A two-dimensional representation of three-dimensional geographic data is displayed, and a user input is received specifying an initial location on the two-dimensional representation. Additional user input is received specifying a number of intermediate locations and terminating with a final location. While receiving the additional user input, either a great circle path or rhumb line is dynamically displayed extending from the initial location toward each of the intermediate locations and ultimately terminating at the final location.

### BACKGROUND

The following disclosure relates to computing systems.

The surface of the Earth can be represented with reasonable accuracy in three-dimensions, for example, by a globe, but becomes distorted when represented in two-dimensions, for example, by a map. Electronic maps that can be displayed to a user on an electronic display screen are readily accessible, particularly with the emergence of the Internet. Conventional electronic tools are available that allow a user to interact with an electronic map to measure a distance and trace a path between two or more geographic locations represented on the map.

A geodesic path is the shortest path between two points on any mathematically defined surface. For example, the geodesic path on a sphere is referred to as the great circle path (or an orthodrome), where a great circle is a circle described by the intersection of the surface of the sphere with a plane passing through the center of the sphere. On the Earth, the equator represents a great circle, as do the meridians of longitude, since their planes intersect the center of the Earth; however, the lines of latitude around the Earth are not great circles (with the exception of the equator as noted above). The great circle path between two points on the surface of the sphere is a segment of such a great circle starting at a first point and ending at a second point. The shortest distance between two points on the surface of the Earth is often referred to as the great circle path, although technically the Earth is not a perfect sphere, and is actually an ellipsoid. However, to conform to common parlance, the term “great circle path” is used herein to describe the shortest path between two points on the Earth's surface.

A conventional electronic tool that allows user interaction with an electronic map may indicate the great circle distance between two or more geographic locations on the Earth's surface, and may also include a visual display of a path between the two or more locations. A straight line drawn on a two-dimensional representation of the Earth's surface will not represent the great circle path (except within certain limits of Azimuthal projections and particularly within a Gnonomic projection), due to inherent distortions when depicting the three-dimensional Earth's surface in a two-dimensional plane. For example, FIG. 1 shows a path 5 on a two-dimensional representation of the United States 10 between two cities, Sacramento 15 on the west coast and Boston 20 on the east coast. A text box, 25 indicates a great circle distance of 2621.31 miles and an initial direction of 68.7°. Although the great circle distance is accurately indicated as 2621.31 miles, the path 5 depicted between Sacramento 15 and Boston 20 is a straight line that does not represent the great circle path.

### SUMMARY

The following describes apparatus and techniques relating to displaying a projection sensitive path on a two-dimensional representation of a three-dimensional object. In general, in one aspect, the invention features dynamically displaying a path between at least two geographic locations. A two-dimensional representation of three-dimensional geographic data is displayed, and a user input is received specifying an initial location on the two-dimensional representation. Additional user input is received specifying a number of intermediate locations and terminating with a final location. While receiving the additional user input, a great circle path is dynamically displayed extending from the initial location toward each of the intermediate locations and ultimately terminating at the final location.

Implementations of the invention can include one or more of the following. Receiving a user input specifying the initial location can include receiving input corresponding to a user positioning a cursor over the initial location on the two-dimensional representation and inputting a first cursor position. Receiving additional user input specifying a plurality of intermediate locations can include receiving input corresponding to a user dragging the cursor on the two-dimensional representation from the first cursor position to a position over the final location. Alternatively, receiving additional user input specifying a plurality of intermediate locations can include receiving input corresponding to a user positioning the cursor over the final location on the two-dimensional representation and inputting a second cursor position.

A great circle distance can be displayed corresponding to the great circle path, and can be dynamically updated based on the additional user input while receiving the additional user input. An initial direction can be displayed corresponding to the great circle path, and can be dynamically updated based on the additional user input while receiving the additional user input.

Additional user input can be received specifying at least one additional final location on the two-dimensional representation. While receiving the additional user input, a second path can be dynamically displayed extending from a final location toward the additional final location, the second path terminating at the additional final location upon completion of receipt of the additional user input. The second path represents a great circle path between the final location and the additional final location. A total great circle distance, being the sum of a great circle distance corresponding to the great circle path between the initial location and the final location and the great circle distance corresponding to the second path between the final location and the additional final location, can be displayed.

Displaying a great circle path extending from the initial location toward each of the plurality of intermediate locations and terminating at the final location, can include displaying a first portion of the path, the first portion extending from the initial location to an outer boundary of the two-dimensional representation, and displaying a second portion of the path, the second portion extending from an outer boundary of the two-dimensional representation to the final location. A graphical element can be displayed linking the first portion of the path to the second portion of the path, wherein the first portion and the second portion together comprise the great circle path between the initial location and the final location.

In general, in another aspect, the invention features dynamically displaying an area bounded by great circle paths. A two-dimensional representation of three-dimensional geographic data is displayed, and user input specifying at least three locations on the two-dimensional representation, each location representing a vertex defining an area, is received. A boundary path is displayed between adjacent locations, thereby enclosing the area, where each boundary path represents a great circle path between the adjacent locations. A value of a three-dimensional area represented by the enclosed area on the two-dimensional representation is displayed.

Implementations can include one or more of the following. A great circle distance corresponding to a cumulative distance of the boundary paths between adjacent locations can be displayed. A user input specifying a modification to at least one of the locations can be received, and a modified value of a three-dimensional area represented by the modified enclosed area on the two-dimensional representation can be displayed. A modified great circle distance corresponding to a modified cumulative distance of the boundary paths between adjacent locations can also be displayed.

Displaying a boundary path between at least two of the locations can include displaying a first portion of the boundary path, the first portion extending from a first location to an outer boundary of the two-dimensional representation, and displaying a second portion of the boundary path, the second portion extending from an outer boundary of the two-dimensional representation to an adjacent, second location. A graphical element can be displayed linking the first portion of the boundary path to the second portion of the boundary path, wherein the first portion and the second portion together comprise the great circle path between the first location and the second location.

In general, in another aspect, a path of constant direction, i e., a loxodrome or a rhumb line, can be dynamically displayed between at least two geographic locations. A two-dimensional representation of three-dimensional geographic data is displayed, and a user input specifying an initial location on the two-dimensional representation is received. Additional user input specifying a plurality of intermediate locations and terminating with a final location is also received, and a rhumb line is dynamically displayed extending from the initial location toward each of the plurality of intermediate locations and ultimately terminating at the final location.

In one implementation, a distance corresponding to the distance of the path of constant direction can be displayed, including a dynamically updated distance based on the additional user input while receiving the additional user input.

Implementations of the invention can realize one or more of the following advantages. A user can interact with an electronic two-dimensional representation of geographic data to trace a path on the representation, while receiving immediate visual feedback indicating a great circle path extending from an initial end of the path to a changing terminal end of the path. Additional information can also be immediately and dynamically provided to the user, including the corresponding great circle distance and the initial direction of the great circle path. The immediate feedback allows a user to plot a path, while dynamically taking into consideration a number of factors, including the shortest distance between two locations, the geography underlying the path and intermediate locations along the path.

Measuring and visualizing the great circle path between two or more locations on the Earth's surface can be useful for a number of reasons. For example, when traveling by sea or air, where travel paths are flexible, knowing the great circle path from an initial location to a final location can significantly reduce travel time and expenses. Utility companies, such as telephone companies laying fiber optic cable or natural gas providers laying pipeline, may require the great circle path between two locations, in order to lay the least amount of fiber optic cable or pipe as necessary. A visualization of the great circle path can provide useful information about underlying geography, for example, whether or not the path extends across a body of water or other such challenging terrain. Seismic waves tend to travel along great circle paths, and thus an accurate visualization of a great circle path can be advantageous to someone studying seismic waves, such as geologist.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a representation of a path between Sacramento and Boston on an electronic map depicting North America (prior art).

FIG. 2A shows a representation of a mapping application resident on a hard-drive of a computer.

FIG. 2B shows a representation of a great circle path between Sacramento and Boston on an electronic map depicting North America.

FIG. 2C shows a representation of a great circle path between Sacramento and a location in Illinois on an electronic map depicting North America.

FIG. 2D is a flowchart showing a process for displaying a great circle path.

FIG. 3 shows a representation of a great circle path between Alaska and Brazil and a great circle path between Brazil and Ireland on an electronic map depicting the World.

FIG. 4 is a flowchart showing a process for displaying a series of great circle paths between a series of locations.

FIG. 5 shows an area enclosed by perimeter boundaries representing great circle paths between adjacent vertices defining the area on an electronic map depicting the World.

FIG. 6 is a flowchart showing a process for defining an enclosed area on an electronic map.

FIG. 7A shows a representation of a path between Greenland and Australia on an electronic map depicting the World.

FIG. 7B shows a representation of a great circle path between Greenland and Australia on an electronic map depicting the World.

FIG. 7C shows a representation of a great circle path when using a wrap-around technique.

FIG. 8 is a flowchart showing a process for displaying a great circle path in at least two separate portions connected by a graphical connector.

FIG. 9 is a flowchart showing a process for mapping between screen coordinates and corresponding geographic coordinates.

FIG. 10 is a representation of a great circle path.

FIG. 11 is a flowchart showing a process for calculating and displaying a representation of a great circle path in two-dimensions.

Like reference symbols in the various drawings indicate like elements.

### DETAILED DESCRIPTION

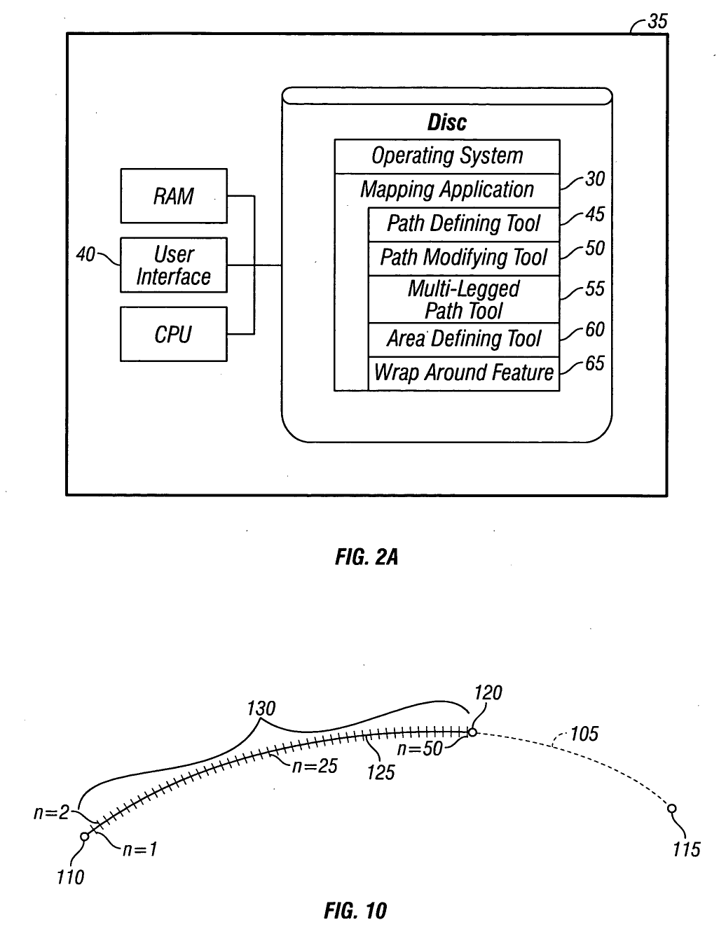

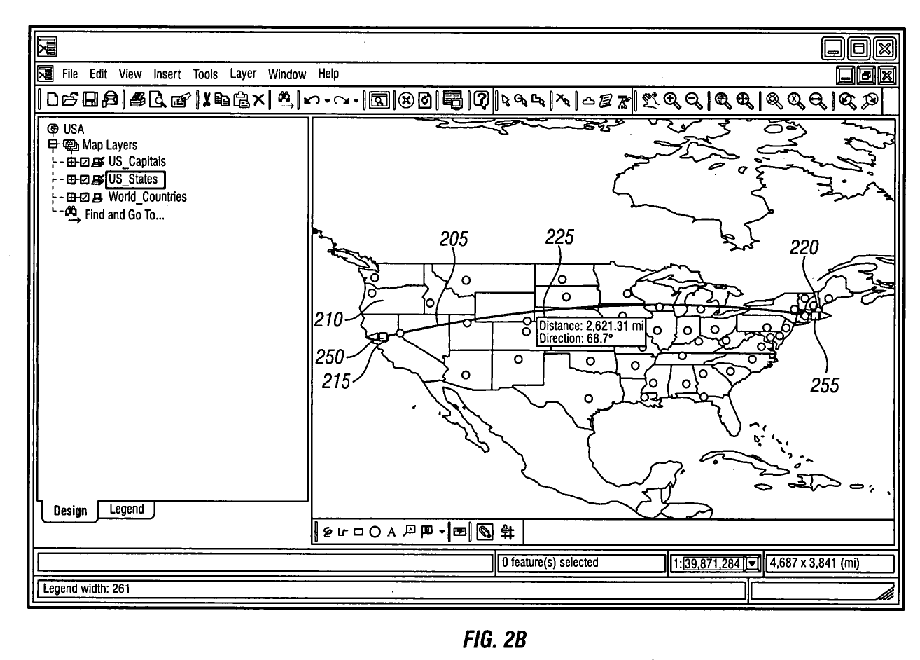

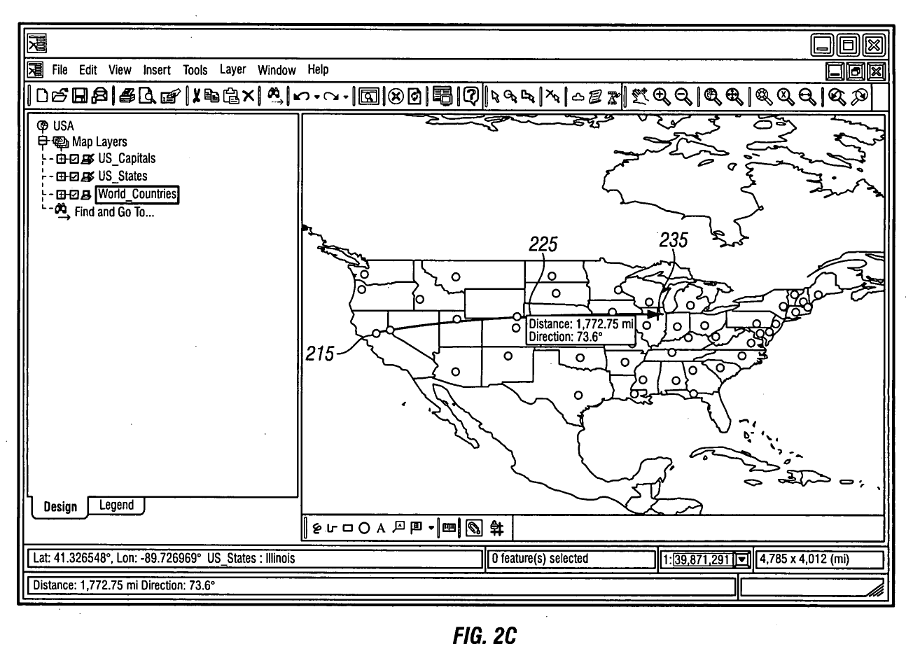

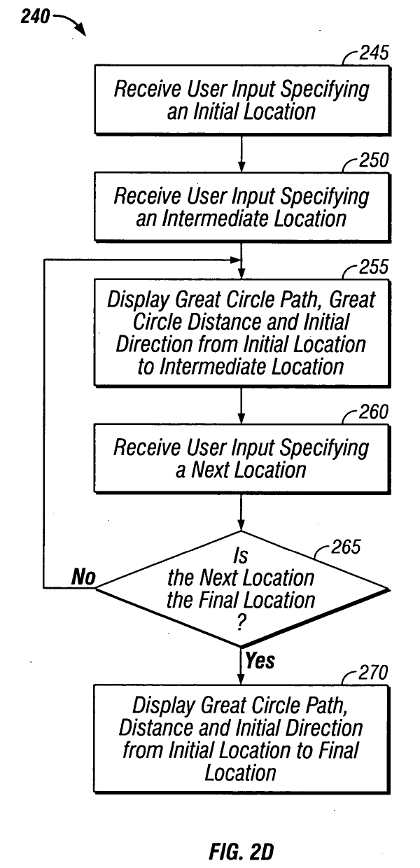

Referring to FIG. 2A, a mapping application 30 executing on a computer 35 having a user interface 40 (e.g., a visual display screen) can be used to visually display three-dimensional information in a two-dimensional environment, such as geographic data. A graphical user interface can be displayed on the display screen, for example, the graphical user interface shown in FIG. 2B. In another implementation, the mapping application 30 can execute on a server (not shown) in communication with the computer 35.

The mapping application 30 includes a set of tools 45-65 that allow user interaction with a two-dimensional representation of geographic data, such as an electronic map. The mapping application can provide immediate visual feedback about the location of a great circle path between locations displayed on the electronic map, the corresponding great circle distance and an initial direction of the great circle path. The set of tools can include a path defining tool 45, a path modifying tool 50, a multi-legged path tool 55, an area defining tool 60 and a wrap around feature 65.

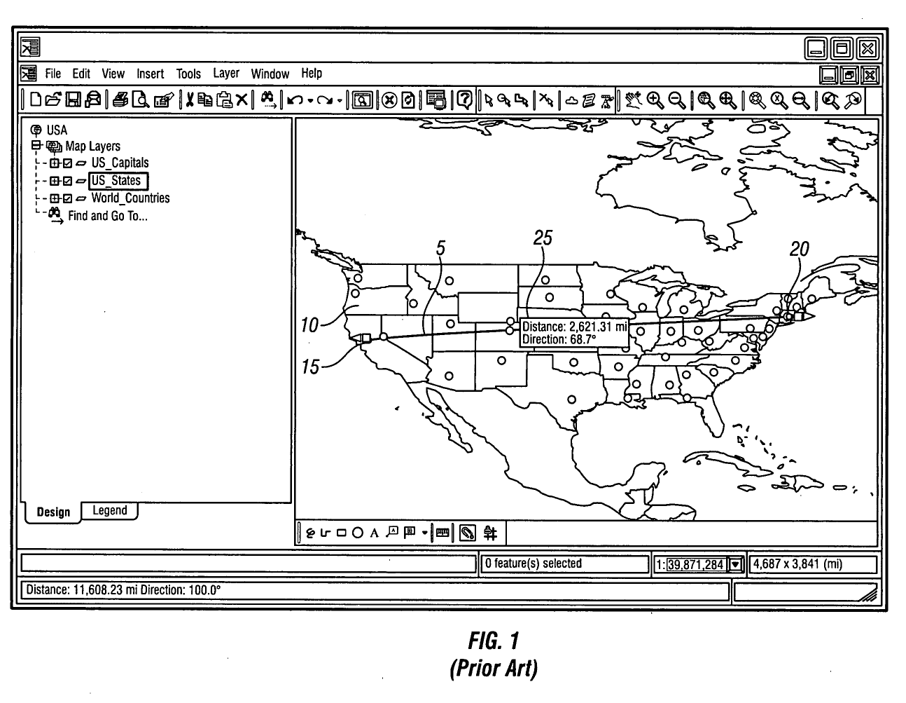

Referring to FIG. 2B, a great circle path 205 is shown on a two-dimensional representation of the United States 210 between Sacramento 215 and Boston 220. The path 205 is curved and forms an arc between the two locations 215, 220. It is apparent from the visualization shown in FIG. 2B that the geography underlying the great circle path 205 includes the great lakes, which clearly is not depicted by the straight path 5 shown in FIG. 1.

Path Defining T ol

Immediate visual feedback about a great circle path allows a user to plot a path while dynamically taking into consideration a number of factors such as, the shortest distance between two locations, the projected representation of underlying geography of the path, and intermediate locations. FIG. 2D is a flowchart showing a process 240 for user interaction with a two-dimensional representation of geographic data. Using the path defining tool 45, a user can interact with the two-dimensional representation, such as an electronic map, to specify an initial location, such as Sacramento 215, for example, by positioning a cursor over Sacramento 215 on the display screen and left-clicking a mouse controlling the cursor (Step 245). The user can then move the cursor toward a final location, for example, by dragging a cursor over the electronic map 210.

As the user moves the cursor across the United States from Sacramento 215 toward Boston 220, the cursor is temporarily positioned over an intermediate location at each new pixel location of the cursor (Step 250). A great circle path is continuously shown extending from the initial location, Sacramento 215, to each new intermediate location of the cursor, thereby providing the user with an immediate visualization of the great circle path 205 (Step 255). For example, FIG. 2C shows a portion of the great circle path, while the cursor is temporarily positioned over one such intermediate location 235, a location in Illinois. At the same time, a text box 225 displays the corresponding great circle distance and initial direction of the great circle path, and is also continuously displayed and dynamically updated (Step 255). The user continues to move the cursor, thereby specifying subsequent intermediate locations (Step 260 and “No” branch of Decision Step 265), until the user specifies a final location (“Yes” branch of decision Step 265), for example, by releasing the mouse. The great circle path, distance and initial direction, from the initial location to the final location is displayed (Step 270).

Path Modifying Tool

Referring to FIG. 2B, grips 250, 255 are shown at the initial and terminating ends of the great circle path 205. Using the path modifying tool 50, a user can manipulate a grip to modify either the initial location or final location. For example, a user can click on the grip 255 associated with the terminating end of the great circle path 205 and drag the grip toward a new final location. As the user drags the grip 255, the great circle path 205 is dynamically modified, such that a great circle path is displayed for a path extending from the initial location, e.g., Sacramento 215, to the changing final location. The information displayed in the text box 225 dynamically updates in correspondence with the changing final location.

Multi-Legged Path Tool

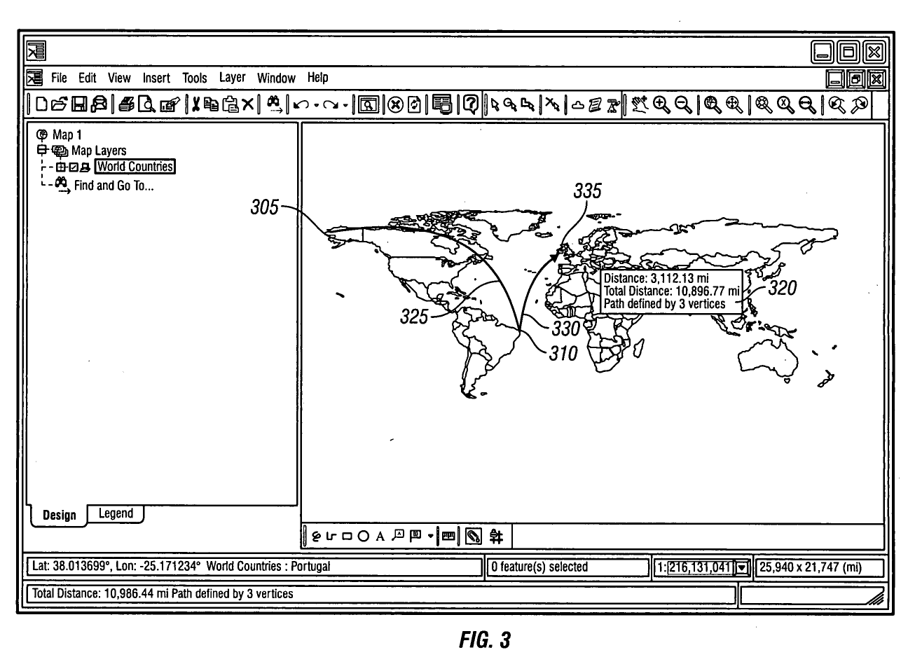

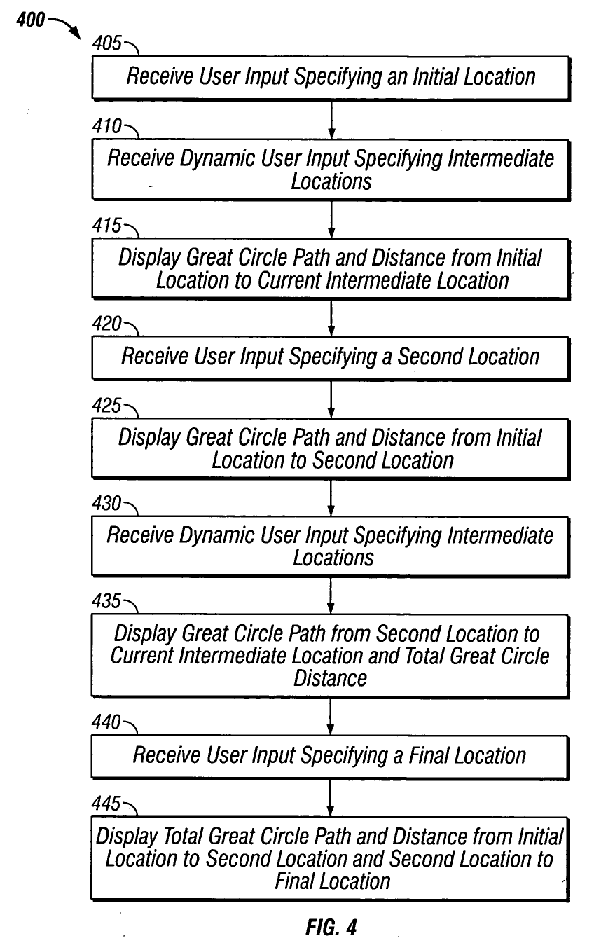

Using the multi-legged path tool 55, a user can specify a path between more than two locations. For example, referring to FIG. 3, consider a pilot plotting a flight path for a journey initiating in Alaska, landing first in Brazil and then carrying on to a point in Ireland. FIG. 4 shows a process 400 for using the multi-legged path tool 55 with an electronic map to specify a multi-legged path, such as the path including a first leg 325 and a second leg 330 shown in FIG. 3. A user can specify the initial location in Alaska 305 (Step 405) and specify a second location in Brazil 310, for example, by moving a cursor from the initial location 305 toward and terminating at Brazil 310. As the user moves toward Brazil 310, thereby specifying intermediate locations (Step 410), a great circle path between Alaska 305 and the continually changing second location (i.e., a current intermediate location) is displayed, as well as a text box 320 displaying the great circle distance and initial direction of the great circle path (Step 415). The user specifies Brazil 310 as the second location (Step 420), for example, by clicking a mouse used to control a cursor displayed on the electronic map. The great circle path 325 between Alaska 305 and Brazil 310 and the text box 320 indicating the great circle distance are displayed (Step 425).

The user moves the cursor from the second location 310 toward a final location, thereby specifying intermediate locations between the second location and the final location (Step 430). The great circle path 325 between Alaska 305 and Brazil 310 continues to be displayed, at the same time as a great circle path 330 extending from the second location, Brazil 310 to a current intermediate location between Brazil 310 and the final location (Step 435). The text box 320 is displayed and continuously updated with the cumulative distance of the great circle path 325 between the initial location 305, the second location 310 and the current intermediate location (Step 435), as well as the great circle distance of the current leg of the path, as the user moves the cursor toward the final location. Once the user specifies a point in Ireland as the final location 335 (Step 440), for example, by clicking the mouse controlling the cursor, the total great circle distance of the great circle path 325 between the initial location 305 and the second location 310, and the second location 310 and the final location 335, is displayed in the text box 320 (Step 445). Additionally, as shown, the text box 320 can describe the path, for example, as a “path defined by 3 vertices”. The user can specify any number of additional locations, to form a multi-legged path.

Area Defining Tool

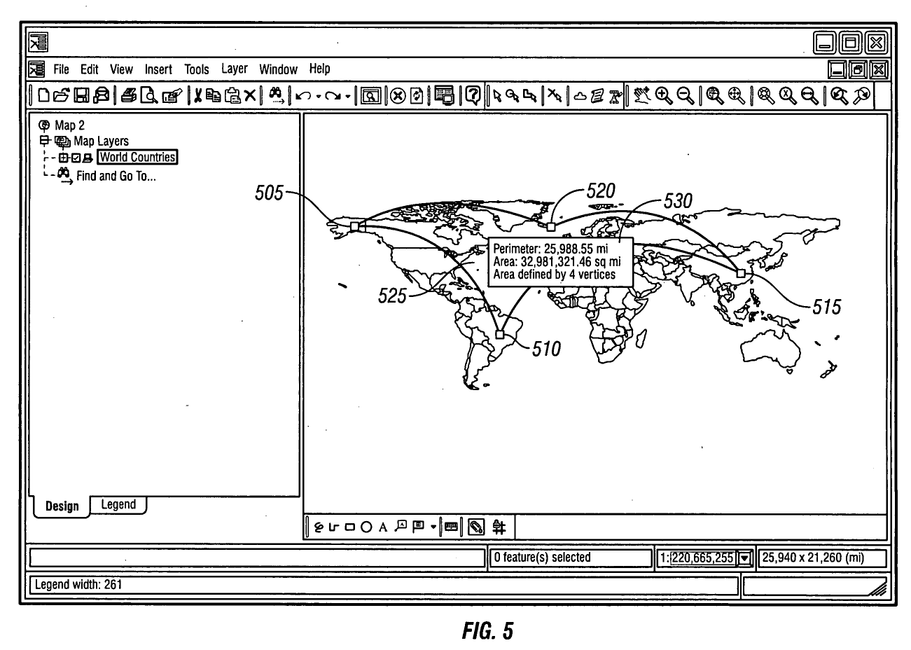

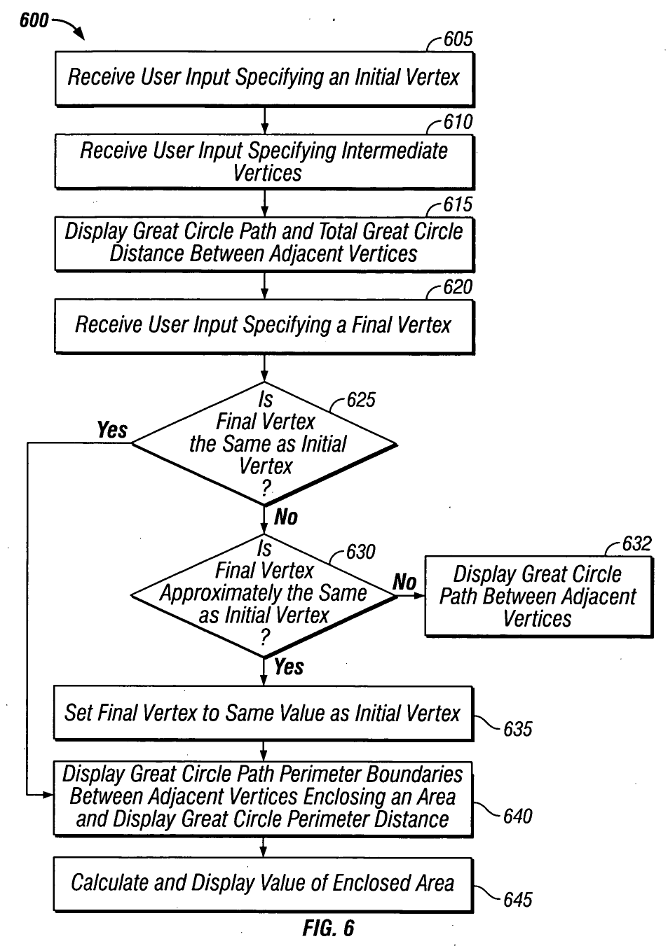

The area defining tool 60 permits a user to define an area on an electronic map and, the value of which is then displayed. For example, referring to FIG. 5, a two-dimensional electronic map of the world is shown, with an area 525 defined by a series of boundary paths representing great circle paths. FIG. 6 is a flowchart showing a process 600 for using the area defining tool 60 with an electronic map to specify an enclosed area. In a similar manner as described above with respect to a user defining a path, the user specifies an initial location 505 (referred to as a “vertex”) (Step 605) and, in this example, three intermediate vertices 510, 515 and 520 (Step 610). A final vertex, which coincides with the initial vertex 505 (Step 620 and “Yes” branch of decision Step 625), is specified, thereby defining an enclosed area 525.

As the user is defining the vertices, the great circle path along each boundary is immediately displayed (Step 615). A text box 530 is displayed and continually updated with the total distance, being the sum of great circle distances between each adjacent vertex. Once the final location is specified, thereby defining the area 525, the value of the area is displayed in the text box 530 with the total perimeter distance, and optionally a description of the area, for example, “area defined by 4 vertices” (Steps 640, 645).

In one implementation, if the user specifies a final vertex near, but not identical to, the initial vertex (“No” branch of Decision Step 625 and “Yes” branch of Decision Step 630), the area defining tool 60 will automatically set the final vertex to coincide with the initial vertex (Step 635), and determine the enclosed area accordingly. For example, if a final vertex is specified within approximately 9 to 11 pixels of an initial vertex, then the area defining tool 60 modifies the final vertex to be the same as the initial vertex. If a user specifies a final vertex that is not the same as or near to the initial vertex (“No” branch of Decision Step 625 and “No” branch of Decision Step 630), then a multi-legged path can be displayed between each of the vertices (Step 632), where each leg of the path is a great circle path between two vertices, but an enclosed area is not defined, and no area is therefore calculated nor displayed.

Wrap Around Feature

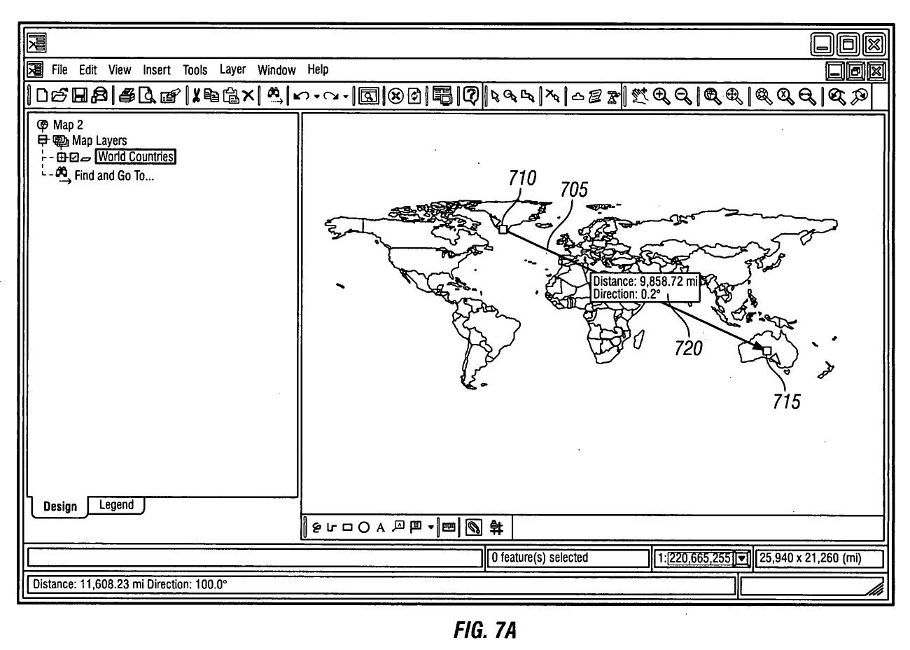

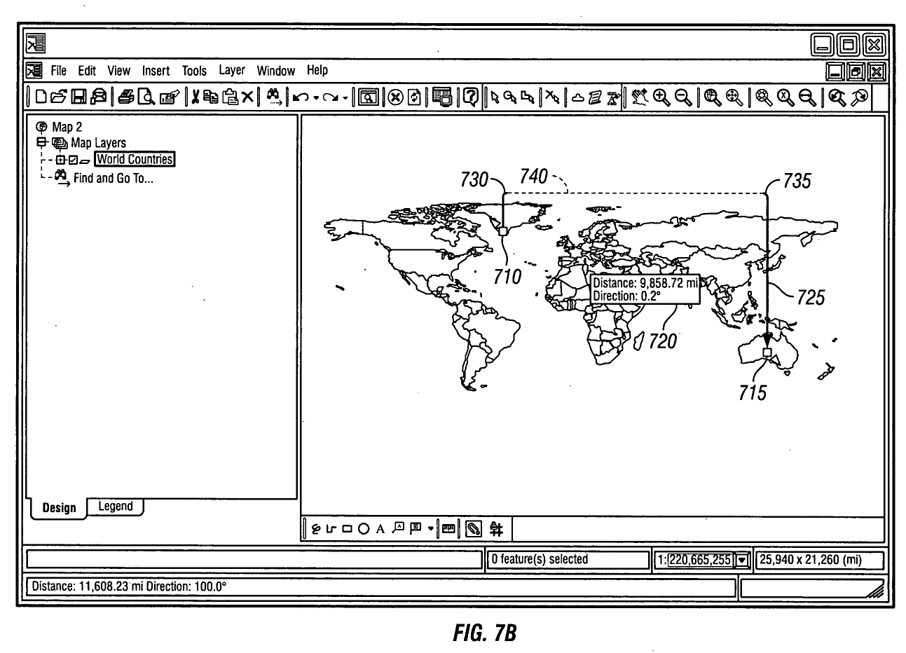

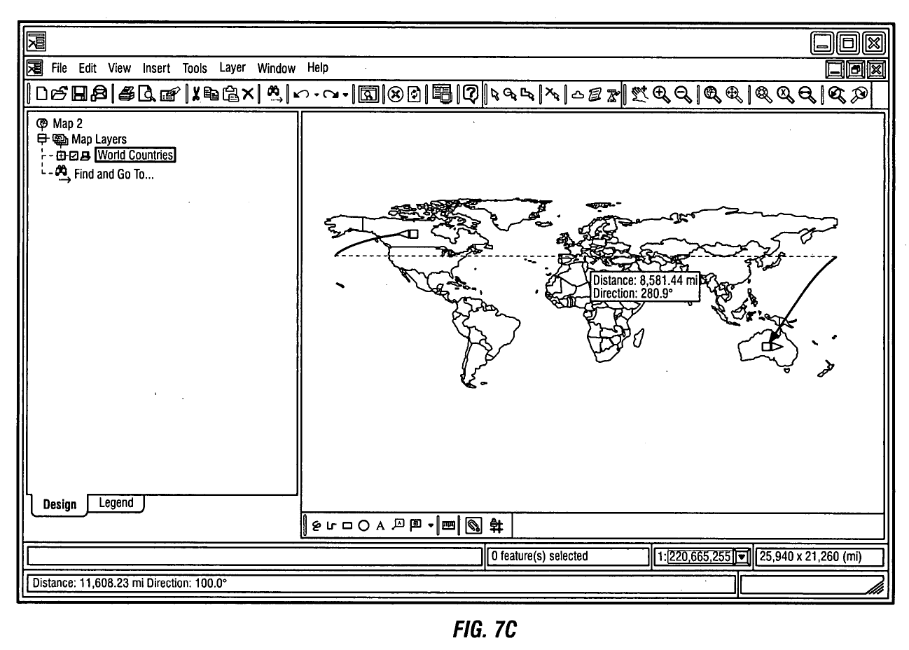

The direction of a great circle path changes continuously with respect to the poles (e.g., North) along the length of the path. Accordingly, in one implementation, the direction displayed to the user in a text box represents the initial direction of the associated great circle path. Visualizing the direction of the great circle path between two locations when represented on a two-dimensional map can be difficult. For example, referring to FIG. 7A, a path 705 is shown connecting an initial location in Greenland 710 to a final location in Australia 715. A text box 720 displays a great circle distance and a direction of the great circle path. The direction is indicated as 0.2°, meaning that the initial direction of the path connecting Greenland 710 to Australia 715 is substantially due North, which is inconsistent with the path 705 displayed, which does not represent the great circle path. Upon visual inspection, one might expect the initial direction of the displayed path 705 to be between 90 and 180 degrees from North.

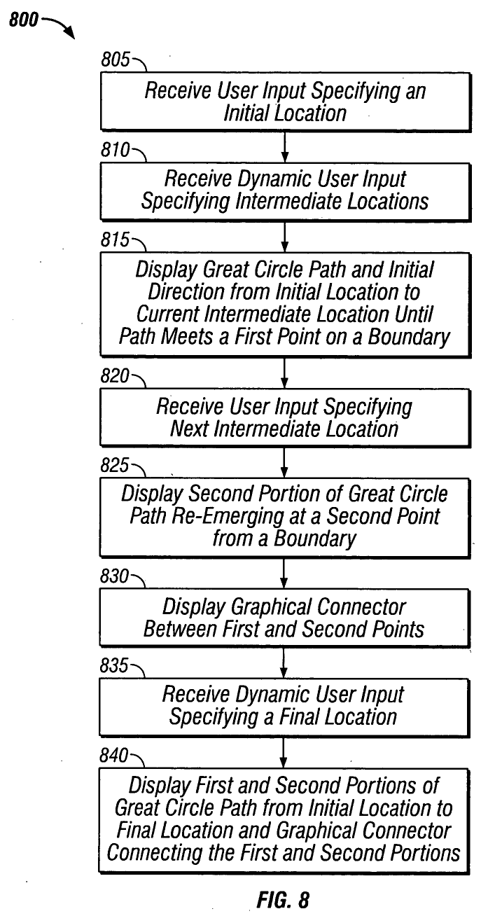

Referring to FIG. 7B, a representation of the great circle path 725 is shown which is visually consistent with the initial direction of the path being substantially due North, as the path actually travels up toward the North pole and then heads south toward Australia. FIG. 8 is a flowchart showing a process 800 using the “wrap around feature” 65 of the mapping application 30 (illustrated in FIG. 7B) to further facilitate visualization of the great circle path in two-dimensions. A user can specify an initial location (Step 805) and dynamically specify intermediate locations (Step 810), for example, by dragging a cursor from the initial location over an electronic map. A great circle path and an initial direction of the great circle path from the initial location to each new intermediate location can be displayed as a continuous path until the path meets a boundary of the electronic map (Step 815). If a great circle path extends to a boundary of the two-dimensional representation of the geographic area, for example, as shown at point 730, then once a next intermediate location has been specified (Step 820), the path re-emerges at a geographically appropriate location on the two-dimensional representation, e.g., point 735, and a second portion of the great circle path is displayed (Step 825). The point of re-emergence can be along the same boundary, for example, as shown in FIG. 7B, or can be at a point on a different boundary, as shown in FIG. 7C. A graphical element 740 is displayed connecting the two portions of the path, in this example, a dashed line (Step 830). Once a final location has been specified (Step 835), the great circle path—having a first and a second portion connected by a graphical element 740—is displayed extending from the initial location to the final location (Step 840).

In one implementation, the wrap around feature 65 is active while a user interacts with the electronic map. Accordingly, if a user specifies an initial location, such as Greenland 710 and moves a cursor toward a final location, such as Australia 715, then at some point the great circle path between Greenland 710 and the moving terminal end of the path will extend the path due North over the North pole and then south towards Australia 715. At that point, the great circle path will be represented by two portions, in a similar manner as shown in FIG. 7B.

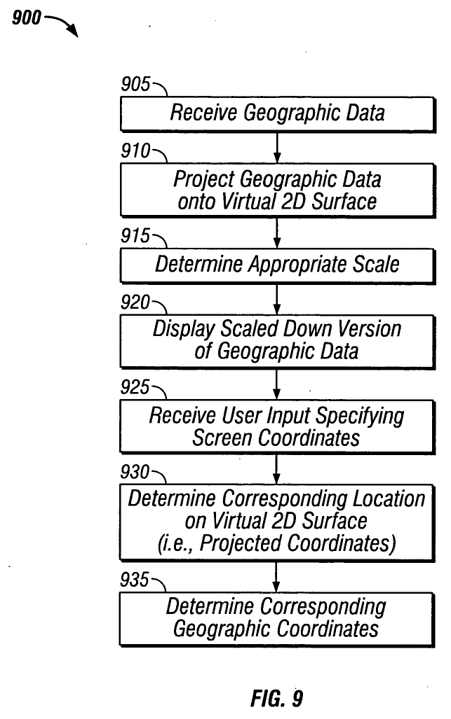

Displaying a Great Circle Path The mapping application 30 is capable of receiving a user input specifying a pixel location on an electronic display screen that visually corresponds to a displayed geographic location, and mapping the pixel location to a corresponding geographic location, for example, as represented by latitude and longitude coordinates. For ease of reference, the term “screen coordinates” shall be used to refer to a pixel location and “geographic coordinates” shall be used to refer to a corresponding latitude and longitude. FIG. 9 shows a method 900 for mapping between screen coordinates of an electronic display screen and corresponding geographic coordinates.

In a first step, geographic data is received describing a geographic area to be visually represented on a display screen (Step 905). For example, geographic data can include a series of data points describing the borders of each state in the United States, the capital city of each state, and the borders of Canada and Mexico, in order to display an electronic map of North America, as shown in FIG. 2A. Additional data can be included that is of particular interest to a user. For example, a utility company may include geographic data describing the locations of pipelines across the United States, or an airline may include geographic data describing the locations of airports.

In one implementation, the geographic data is either received as geographic coordinates of latitude and longitude, and if not, is first converted into latitude and longitude. The geographic coordinates are projected onto a virtual two-dimensional surface (Step 910). Commercially available software, such as the Coordinate System Mapping Library (CS-MAP) available from Mentor Software, Inc. of Golden, Colo., can be used to convert geographic data from a number of different coordinate systems into latitude and longitude, and to project the geographic data onto a virtual two-dimensional surface. Corresponding coordinates on the virtual two-dimensional surface shall be referred to as the “projected coordinates”.

The two-dimensional representation of the geographic data may be required to be scaled down to an appropriate size to fit within an electronic display screen. Accordingly, based on the size of the display screen, an appropriate scale can be determined (Step 915), and a scaled down version of the two-dimensional representation of the geographic data can be displayed (Step 920).

A user input can be received specifying screen coordinates corresponding to a displayed geographic location (Step 925). For example, a user can control a cursor using a mouse, position the cursor over a displayed geographic location (e.g., Sacramento) and left-click the mouse to specify the corresponding screen coordinates. A corresponding geographic location represented by geographic coordinates can be determined from the screen coordinates by reversing the steps described above to map from geographic data to a visual representation on the display screen. That is, projected coordinates on the full scale virtual two-dimensional representation are determined, including scaling up, as necessary, the specified screen coordinates (Step 930). The projected coordinates (i.e., location on the virtual two-dimensional representation) are then used to determine the corresponding geographic coordinates, for example, by using the CS-MAP software described above (Step 935).

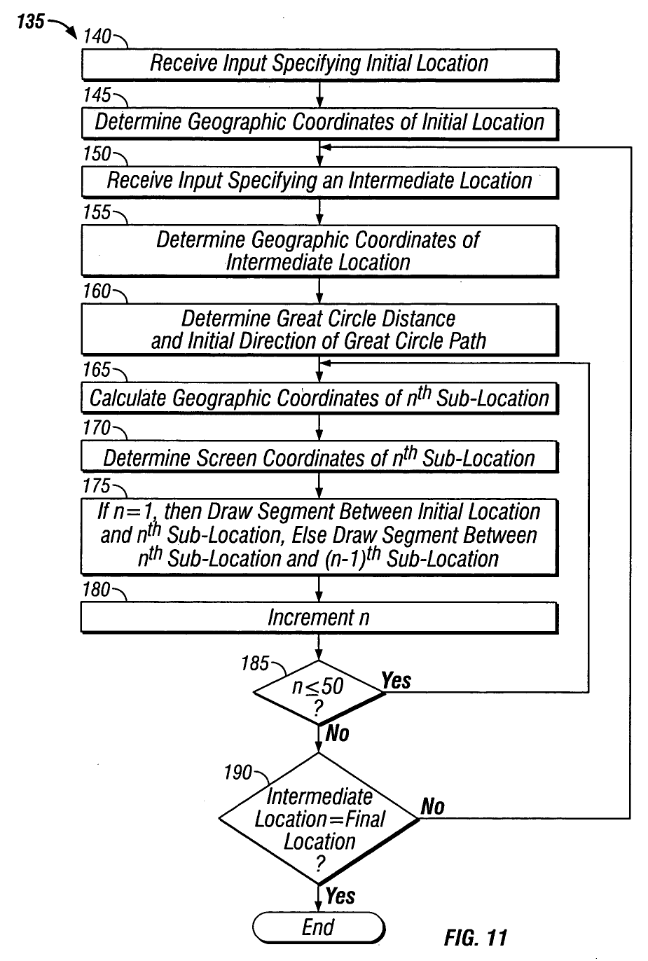

FIG. 10 shows a great circle path 105 having an initial location 110. Although a final location 115 is shown, it is assumed for the purpose of this example that the user has not yet specified the final location 115. In this example, the user is moving a cursor from the initial location 110 toward the final location 115 and the cursor is currently temporarily positioned over an intermediate location 120. A great circle path 125 from the initial location 110 to the intermediate location 120 is shown as a solid line. A technique, such as the one described above, for mapping from screen coordinates to geographic coordinates, and from geographic coordinates to screen coordinates can be used with a process 135 shown in the flowchart depicted in FIG. 11, for displaying a great circle path, such as path 125, on a display screen.

The direction of a great circle path is inherently constantly changing. For example, if a pilot were to fly a plane along a great circle path, the pilot would need to constantly reset the plane's bearings to navigate the path. Accordingly, displaying a two-dimensional representation of the great circle path on a display screen requires displaying a curved line. In one implementation, the representation of the great circle path 125 is actually comprised of a finite number of segments, where each segment is an equal fraction of the great circle distance from the initial location 110 to the intermediate location 120, and a direction of each segment is separately calculated. The number of segments is arbitrary and depends on the desired resolution.

Referring to FIGS. 10 and 11, input is received specifying the initial location 110 in terms of screen coordinates in reference to the user's display screen (Step 140). Using a technique to map from screen coordinates to geographic coordinates, such as the technique described above in reference to FIG. 9, the corresponding geographic coordinates of the initial location 110 are determined (Step 145). As the user moves a cursor toward the final location 115, new intermediate locations are constantly being specified with each new pixel location (i.e., new screen coordinates) of the cursor, for example, intermediate location 120 (Step 150). The corresponding geographic coordinates of the intermediate location 120 are determined (Step 155), and the great circle distance from the initial location 110 to the intermediate location 120 is calculated (Step 160). In one implementation, the great circle distance and the initial direction of the great circle path can be determined using the geographic coordinates of the initial and intermediate locations and commercially available software, such as the CS-MAP software referred to above.

The geographic coordinates of an arbitrary number of “sub-locations” 130 between the initial location 110 and the intermediate location 120 are determined, such that a corresponding number of finite segments can be displayed on the display screen, where the finite segments together represent the great circle path 125 between the initial location 110 and the intermediate location 120. In this example, 50 sub-locations (the 50^{th} sub-location is the same as the intermediate location) will be determined and 50 segments will together represent the great circle path 125.

The geographic coordinates of the 1^{st} sub-location (i.e., n=1, where n is an integer) are determined by calculating 1/50^{th} of the great circle distance from the initial location 110 to the intermediate location 120, and determining the geographic coordinates of a location at 1/50^{th} of the great circle distance in the initial direction of the great circle path, from the initial location 110 (Step 165). For example, consider a relatively simple situation, where the great circle distance from the initial location 110 to the intermediate location 120 is 500 miles, and therefore 1/50^{th} of the distance is 10 miles, and the initial direction of the great circle path is 10°. The 1^{st} sub-location corresponds to a geographic location located 10 miles at a direction of 10° from the initial location 110. In one implementation, the geographic coordinates of the sub-locations can be determined using commercially available software, such as the CS-MAP software referred to above.

Once the geographic coordinates of the 1^{st} sub-location are known, the corresponding screen coordinates can be determined (Step 170), for example, using the technique described above in reference to FIG. 9. A segment of the great circle path 125 can then be displayed on the display screen by displaying a line extending from the initial location 110 to the 1^{st} sub-location (Step 175). The value of n is incremented (Step 180) and the steps 165 to 180 are repeated (“Yes” branch of decision Step 185) until the last (e.g., 50^{th}) segment has been determined (“No” branch of decision Step 185) and the complete great circle path 125 from the initial location 110 to the intermediate location 120 is displayed.

The intermediate location 120 is a temporary location, as the user continues to move the cursor toward the final location 115. Accordingly, at each new temporary location of the cursor, steps 150 through 185 are repeated. That is, for the subsequent temporary location, the corresponding geographic coordinates are determined, so that the great circle distance and initial angle of the great circle path from the initial location 110 to the subsequent intermediate location can be determined. In one implementation, if several cursor moves are detected while the tool is processing, for example, displaying the great circle path, than the most recent cursor position is used as the new temporary location and earlier positions are discarded.

In order to display a representation of the great circle path, the sub-locations between the initial location 110 and the subsequent intermediate location are calculated and the segments together forming the path are displayed. Once the final location has been reached (“Yes” branch of decision Step 190), the great circle path 105 from the initial location 110 to the final location 115 is displayed. In addition to displaying the great circle path, a text box indicating the great circle distance and the initial direction of the great circle path can be continuously displayed and dynamically updated as the intermediate location of the cursor changes.

A multi-legged path, such as the path shown in FIG. 3, can be determined and displayed in a similar manner as described above. The perimeter path of an enclosed area, such as the perimeter path shown in FIG. 5, can also be determined and displayed in a similar manner. The enclosed area can be calculated using well-known mathematical formulae for determining the surface area of an ellipsoid. In one implementation, the geographic coordinates for the vertices defining the enclosed area can be used with commercially available software, such as the CS-MAP software referred to above, to determine the enclosed area (which value can be adjusted for a specific map projection).

The above describes one technique for calculating and displaying the great circle path, represented as a curved line on a two-dimensional display screen, however, other convenient techniques can also be used.

In another implementation, the tools described above can be used to calculate and display a rhumb line or loxodrome, rather than a great circle path. A rhumb line is a path of constant direction as contrasted to a great circle path (or orthodrome), which constantly changes direction. A user can specify an initial location and move a cursor toward a final location. A path is dynamically displayed between the initial and final locations (and temporary, intermediate locations as the user moves the cursor toward the final location) that has a constant direction. For example, sailors often use this technique for charting a course, and once the appropriate direction is determined, the sailor maintains a constant compass direction to travel from an initial location to a final location.

In the rhumb line implementation, a multi-legged path can be charted, by a user specifying an initial location, final location and intermediate locations. The direction of the line and distance of the path can be displayed in a text box, and dynamically updated while a user moves the cursor. An area can be defined, with the perimeter boundary defined by rhumb lines between adjacent vertices. The wrap around feature can be used in the rhumb line implementation in a similar manner as in the great circle path implementation—to provide an accurate visual display of a rhumb line.

The rhumb line can be calculated and displayed on an electronic screen in a similar manner, that is, by approximating a curve by calculating and displaying multiple straight line segments (e.g., 50), except rather than calculate a new direction for each line segment, a constant direction is used. In one implementation, screen coordinates can be transformed to geographic coordinates and visa versa using commercially available software, such as the CS-MAP software described above.

The invention and all of the functional operations described in this specification can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. The logic flows depicted in FIGS. 2D, 4, 6, 8, 9 and 11 do not require the particular order shown, or sequential order, to achieve desirable results, and the steps of the invention can be performed in a different order and still achieve desirable results. Accordingly, other embodiments are within the scope of the following claims.

1. A computer-implemented method for dynamically displaying a path between at least two geographic locations, comprising:
displaying a two-dimensional representation of three-dimensional geographic data;
receiving a user input specifying an initial location on the two-dimensional representation;
receiving additional user input specifying a plurality of intermediate locations and terminating with a final location; and
while receiving the additional user input, dynamically displaying a great circle path extending from the initial location toward each of the plurality of intermediate locations and terminating at the final location.

2. The method of claim 1, wherein:
receiving a user input specifying the initial location comprises receiving input corresponding to a user positioning a cursor over the initial location on the two-dimensional representation and inputting a first cursor position; and
receiving additional user input specifying a plurality of intermediate locations comprises receiving input corresponding to a user dragging the cursor on the two-dimensional representation from the first cursor position to a position over the final location.

3. The method of claim 1, wherein:
receiving user input specifying the initial location comprises receiving user input corresponding to a user positioning a cursor over the initial location on the two-dimensional representation and inputting a first cursor position; and
receiving additional user input specifying a plurality of intermediate locations comprises the receiving input corresponding to a user positioning the cursor over the final location on the two-dimensional representation and inputting a second cursor position.

4. The method of claim 1, further comprising:
displaying a great circle distance corresponding to the great circle path, including dynamically updating the great circle distance based on the additional user input while receiving the additional user input.

5. The method of claim 1, further comprising:
displaying an initial direction corresponding to the great circle path, including dynamically updating the initial direction based on the additional user input while receiving the additional user input.

6. The method of claim 1, further comprising:
receiving additional user input specifying at least one additional final location on the two-dimensional representation; and
while receiving the additional user input, dynamically displaying a second path extending from a final location toward the additional final location, the second path terminating at the additional final location upon completion of receipt of the additional user input and the second path representing a great circle path between the final location and the additional final location.

7. The method of claim 6, further comprising:
displaying a total great circle distance being the sum of a great circle distance corresponding to the great circle path between the initial location and the final location and the great circle distance corresponding to the second path between the final location and the additional final location.

8. The method of claim 1, wherein displaying a great circle path extending from the initial location toward each of the plurality of intermediate locations and terminating at the final location, comprises:
displaying a first portion of the path, the first portion extending from the initial location to an outer boundary of the two-dimensional representation;
displaying a second portion of the path, the second portion extending from an outer boundary of the two-dimensional representation to the final location; and
displaying a graphical element linking the first portion of the path to the second portion of the path, wherein the first portion and the second portion together comprise the great circle path between the initial location and the final location.

9. A computer-implemented method for dynamically displaying an area bounded by great circle paths, comprising:
displaying a two-dimensional representation of three-dimensional geographic data;
receiving a user input specifying at least three locations on the two-dimensional representation, each location representing a vertex where the vertices together define an area;
while receiving the user input, dynamically displaying a boundary path between adjacent locations, where each boundary path represents a great circle path between the adjacent locations and where the boundary paths together enclose an area.

10. The method of claim 9, further comprising:
displaying a value of a three-dimensional area represented by the enclosed area on the two-dimensional representation.

11. The method of claim 10, further comprising:
receiving a user input specifying a modification to at least one of the locations;
dynamically displaying one or more modified boundary paths based on the modification to the at least one location; and
dynamically displaying a modified value of a three-dimensional area represented by a modified enclosed area on the two-dimensional representation.

12. The method of claim 11, further comprising:
dynamically displaying a modified great circle distance corresponding to a modified cumulative distance of the boundary paths between adjacent locations.

13. The method of claim 9, further comprising:
displaying a great circle distance corresponding to a cumulative distance of the boundary paths between adjacent locations.

14. The method of claim 9, wherein displaying a boundary path between at least two of the locations comprises:
displaying a first portion of the boundary path, the first portion extending from a first location to an outer boundary of the two-dimensional representation;
displaying a second portion of the boundary path, the second portion extending from an outer boundary of the two-dimensional representation to an adjacent, second location; and
displaying a graphical element linking the first portion of the boundary path to the second portion of the boundary path, wherein the first portion and the second portion together comprise the great circle path between the first location and the second location.

15. A computer-implemented method for dynamically displaying a path between at least two geographic locations, comprising:
displaying a two-dimensional representation of three-dimensional geographic data;
receiving a user input specifying an initial location on the two-dimensional representation;
receiving additional user input specifying a plurality of intermediate locations and terminating with a final location; and
dynamically displaying a path of constant direction extending from the initial location toward each of the plurality of intermediate locations and ultimately terminating at the final location.

16. The method of claim 15, wherein:
receiving a user input specifying the initial location comprises receiving input corresponding to a user positioning a cursor over the initial location on the two-dimensional representation and inputting a first cursor position; and
receiving additional user input specifying a plurality of intermediate locations comprises receiving input corresponding to a user dragging the cursor on the two-dimensional representation from the first cursor position to a position over the final location.

17. The method of claim 15, wherein:
receiving user input specifying the initial location comprises receiving user input corresponding to a user positioning a cursor over the initial location on the two-dimensional representation and inputting a first cursor position; and
receiving additional user input specifying a plurality of intermediate locations comprises a receiving input corresponding to a user positioning the cursor over the final location on the two-dimensional representation and inputting a second cursor position.

18. The method of claim 15, further comprising:
displaying a distance corresponding to the distance of the path of constant direction, including dynamically updating the distance based on the additional user input while receiving the additional user input.

19. The method of claim 15, further comprising:
displaying a direction of the path of constant direction.

20. A computer program product, tangibly stored on a computer-readable medium, for dynamically displaying a path between at least two geographic locations, comprising instructions operable to cause a programmable processor to:
display a two-dimensional representation of three-dimensional geographic data;
receive a user input specifying an initial location on the two-dimensional representation;
receive additional user input specifying a plurality of intermediate locations and terminating with a final location; and
while receiving the additional user input, dynamically display a great circle path extending from the initial location toward each of the plurality of intermediate locations and ultimately terminating at the final location.

21. The computer program product of claim 20, wherein:
instructions operable to receive a user input specifying the initial location comprise instructions operable to receive input corresponding to a user positioning a cursor over the initial location on the two-dimensional representation and entering a first cursor position; and
instructions operable to receive additional user input specifying a plurality of intermediate locations comprise instructions operable to receive input corresponding to a user dragging the cursor on the two-dimensional representation from the first cursor position to a position over the final location.

22. The computer program product of claim 20, wherein:
instructions operable to receive user input specifying the initial location comprise instructions operable to receive user input corresponding to a user positioning a cursor over the initial location on the two-dimensional representation and entering a first cursor position; and
instructions operable to receive additional user input specifying a plurality of intermediate locations comprise instructions operable to receive input corresponding to a user positioning the cursor over the final location on the two-dimensional representation and entering a second cursor position.

23. The computer program product of claim 20, further comprising instructions operable to:
display a great circle distance corresponding to the great circle path and dynamically update the great circle distance based on the additional user input while receiving the additional user input.

24. The computer program product of claim 20, further comprising instructions operable to:
display an initial direction corresponding to the great circle path and dynamically update the initial direction based on the additional user input while receiving the additional user input.

25. The computer program product of claim 20, further comprising instructions operable to:
receive additional user input specifying at least one additional final location on the two-dimensional representation; and
while receiving the additional user input, dynamically display a second path extending from a final location toward the additional final location, the second path terminating at the additional final location upon completion of receipt of the additional user input and the second path representing a great circle path between the final location and the additional final location.

26. The computer program product of claim 25, further comprising instructions operable to:
display a total great circle distance being the sum of a great circle distance corresponding to the great circle path between the initial location and the final location and the great circle distance corresponding to the second path between the final location and the additional final location.

27. The computer program product of claim 20, wherein instructions operable to display a great circle path extending from the initial location toward each of the plurality of intermediate locations and terminating at the final location, comprise instructions operable to:
display a first portion of the path, the first portion extending from the initial location to an outer boundary of the two-dimensional representation;
display a second portion of the path, the second portion extending from an outer boundary of the two-dimensional representation to the final location; and
display a graphical element linking the first portion of the path to the second portion of the path, wherein the first portion and the second portion together comprise the great circle path between the initial location and the final location.

28. A computer program product, tangibly stored on a computer-readable medium, for displaying an area bounded by great circle paths, comprising instructions operable to cause a programmable processor to:
display a two-dimensional representation of three-dimensional geographic data;
receive a user input specifying at least three locations on the two-dimensional representation, each location representing a vertex where the vertices together define an area;
while receiving the user input, dynamically display a boundary path between adjacent locations, where each boundary path represents a great circle path between the adjacent locations and where the boundary paths together enclose an area.

29. The computer program product of claim 28, further comprising instructions operable to:
display a value of a three-dimensional area represented by the enclosed area on the two-dimensional representation.

30. The computer program product of claim 29, further comprising instructions operable to:
receive a user input specifying a modification to at least one of the locations;
dynamically display one or more modified boundary paths based on the modification to the at least one location; and
dynamically display a modified value of a three-dimensional area represented by a modified enclosed area on the two-dimensional representation.

31. The computer program product of claim 30, further comprising instructions operable to:
dynamically display a great circle distance corresponding to a modified cumulative distance of the boundary paths between adjacent locations.

32. The computer program product of claim 28, further comprising instructions operable to:
display a great circle distance corresponding to a cumulative distance of the boundary paths between adjacent locations.

33. The computer program product of claim 28, wherein instructions operable to display a boundary path between at least two of the locations comprise instructions operable to:
display a first portion of the boundary path, the first portion extending from a first location to an outer boundary of the two-dimensional representation;
display a second portion of the boundary path, the second portion extending from an outer boundary of the two-dimensional representation to an adjacent, second location; and
display a graphical element linking the first portion of the boundary path to the second portion of the boundary path, wherein the first portion and the second portion together comprise the great circle path between the first location and the second location.

34. A computer program product, tangibly stored on a computer-readable medium, for dynamically displaying a path between at least two geographic locations, comprising instructions operable to cause a programmable processor to:
display a two-dimensional representation of three-dimensional geographic data;
receive a user input specifying an initial location on the two-dimensional representation;
receive additional user input specifying a plurality of intermediate locations and terminating with a final location; and
dynamically display a path of constant direction extending from the initial location toward each of the plurality of intermediate locations and terminating at the final location.

35. The computer program product of claim 34, wherein:
instructions operable to receive a user input specifying the initial location comprise instructions operable to receive input corresponding to a user positioning a cursor over the initial location on the two-dimensional representation and entering a first cursor position; and
instructions operable to receive additional user input specifying a plurality of intermediate locations comprise instructions operable to receive input corresponding to a user dragging the cursor on the two-dimensional representation from the first cursor position to a position over the final location.

36. The computer program product of claim 34, wherein:
instructions operable to receive user input specifying the initial location comprise instructions operable to receive user input corresponding to a user positioning a cursor over the initial location on the two-dimensional representation and entering a first cursor position; and
instructions operable to receive additional user input specifying a plurality of intermediate locations comprise instructions operable to receive input corresponding to a user positioning the cursor over the final location on the two-dimensional representation and entering a second cursor position.

37. The computer program product of claim 34, further comprising instructions operable to:
display a distance corresponding to a distance of the path of constant direction and dynamically update the distance based on the additional user input while receiving the additional user input.

38. The computer program product of claim 34, further comprising instructions operable to:
display a direction of the path of constant direction.
